(19) United States
(12) Patent Application Publication
(10) Pub. No.: US 2020/0173872 A1
(43) Pub. Date: Jun. 4, 2020

(54) TIRE LOAD ESTIMATION METHOD AND TIRE LOAD ESTIMATION DEVICE

(71) Applicant: BRIDGESTONE CORPORATION, Tokyo (JP)

(72) Inventor: Shogo TAKEDOMI, Tokyo (JP)

(73) Assignee: BRIDGESTONE CORPORATION, Tokyo (JP)

(21) Appl. No.: 16/621,789

(22) PCT Filed: Sep. 3, 2018
(86) PCT No.: PCT/JP2018/032526

§ 371 Date: Dec. 12, 2019

(30) Foreign Application Priority Data
Sep. 11, 2017 (JP) 2017-174301

(51) Int. Cl. G01L 5/00; B60C 23/06; B60C 23/04

(52) U.S. Cl. CPC G01L 5/00; G01P 15/00; B60C 23/0488; B60C 23/061

(57) ABSTRACT

A tire load estimation device includes: acceleration sensors; a total vehicle weight calculating device; an acceleration waveform extracting device; a differential acceleration waveform calculating device; a peak position detecting device detecting peak positions on leading and trailing edge sides in the differential acceleration waveform; a ground contact time ratio calculating device calculating ground contact and rotation times from the peak positions to calculate a ground contact time ratio; and a lord estimating device estimating the load acting on the tire from the ground contact time ratio of each tire, a maximum load capability of the tire, the total vehicle weight, and an inclination obtained in advance by approximating a maximum load capability ratio, which is a value obtained by normalizing the load with the maximum load capability, with a linear function of the ground contact time ratio.

### TECHNICAL FIELD

The present invention relates to a method and a device for estimating a load acting on a tire by using an output signal of an acceleration sensor disposed on an inner surface side of a tire tread of the tire.

### BACKGROUND

Conventionally, there has been proposed a method for estimating a load acting on a tire while a vehicle is running, in which a plurality of piezoelectric elements for detecting a change of the load in a circumferential direction and a plurality of piezoelectric elements for detecting a change of the load in a width direction are disposed respectively on an inner surface side of a tire tread; a ground contact area of the tire is calculated on the basis of a ground contact length in the tire circumferential direction detected from the change of the load in the circumferential direction and a ground contact width in the tire width direction detected from the change of the load in the width direction; an air pressure of the tire is measured; and the load acting on the tire is estimated from the measured air pressure and the calculated ground contact area (see, for example, Patent Document 1).

### CITATION DOCUMENT

### Patent Document

Patent Document 1: Japanese Unexamined Patent Application Laid-open No. 2012-218682

### SUMMARY OF THE INVENTION

### Technical Problem

However, there has been a problem that, in the method described in Patent Document 1, because it is configured to detect changes of the load in the circumferential direction and in the width direction, it has been necessary to dispose a plurality of sensors (piezoelectric elements) on an inner surface side of each tire tread. In addition, in Patent Document 1, because the load is estimated using the ground contact area, although the air pressure has been taken into consideration, accuracy of the load estimation has not been sufficient.

The present invention has been made in view of the conventional problem and aims at providing a method and a device capable of precisely estimating a load acting on a tire with less sensors.

### Solution to Problem

The present invention provides a method for estimating a load acting on a tire mounted on a vehicle, the method including: a step of detecting an acceleration waveform in a tire radial direction of each tire from an output of each of acceleration sensors disposed on an inner surface side of a tire tread of each tire of the vehicle; a step of calculating a total vehicle weight; a step of differentiating the acceleration waveform in the tire radial direction of each tire to obtain a differential acceleration waveform; a step of calculating a ground contact time and a rotation time of the tire from the differential acceleration waveform; a step of calculating, for each tire, a ground contact time ratio which is a ratio between the ground contact time and the rotation time; and a step of estimating a load acting on a target tire, which is a target for estimation of the load, from the calculated ground contact time ratio of each tire, a maximum load capability of the target tire, the calculated total vehicle weight, and an inclination obtained in advance by approximating a maximum load capability ratio with a linear function of the ground contact time ratio, in which the maximum load capability ratio of the target tire is a value obtained by normalizing the load acting on the target tire with the maximum load capability of the target tire.

The present invention also provides a device for estimating a load acting on a tire mounted on a vehicle, the device including: acceleration sensors each disposed on an inner surface side of a tire tread of each tire of the vehicle and each being configured to detect an acceleration in a tire radial direction of each tire; a total vehicle weight calculating means that calculates a total vehicle weight; an acceleration waveform extracting means that extracts, for each tire, an acceleration waveform in the tire radial direction including a vicinity of a contact patch from an output signal of each of the acceleration sensors; a differential calculating means that differentiates the acceleration waveform in the tire radial direction to obtain a differential acceleration waveform; a peak position detecting means that detects a peak position on a leading edge side and a peak position on a trailing edge side, the peak positions being peak positions at two ground contact ends appearing in the differential acceleration waveform; a ground contact time calculating means that calculates a ground contact time which is an interval between the peak position on the leading edge side and the peak position on the trailing edge side: a rotation time calculating means that calculates a rotation time, which is a time required for the tire to rotate for one rotation, from an interval between two adjacent peak positions on the leading edge side or two adjacent peak positions on the trailing edge side in the acceleration waveform in the tire radial direction; a ground contact time ratio calculating means that calculates, for each tire, a ground contact time ratio which is a ratio between the ground contact time and the rotation time; and a lord estimating means that estimates the load acting on a target tire, which is a target for estimation of the load, from the calculated ground contact time ratio of each tire, a maximum load capability of the target tire, the calculated total vehicle weight, and an inclination obtained in advance by approximating a maximum load capability ratio with a linear function of the ground contact time ratio, in which the maximum load capability ratio of the target tire is a value obtained by normalizing the load acting on the target tire with the maximum load capability of the target tire.

The summary of the invention does not enumerate all the features required for the present invention, and sub-combinations of these features may also become the invention.

### BRIEF DESCRIPTION OF THE DRAWINGS

FIG. 1 is a diagram illustrating a configuration of a tire load estimation device according to an embodiment of the present invention;

FIGS. 2(a) and 2(b) are diagrams illustrating an example how acceleration sensors and total vehicle weight calculating means are mounted;

FIGS. 3(a) and 3(b) are diagrams illustrating an example of an acceleration waveform and a differential acceleration waveform, respectively;

FIG. 4 is a diagram illustrating a relationship among the differential acceleration waveform, a ground contact time and a rotation time;

FIG. 5 is a flowchart illustrating a tire load estimation method according to the present embodiment; and

FIG. 6 is a diagram illustrating a relationship between a ground contact time ratio and a load; and

FIG. 7 is a diagram illustrating a relationship between the ground contact time ratio and a maximum load capability ratio.

### DESCRIPTION OF EMBODIMENT

### Embodiment

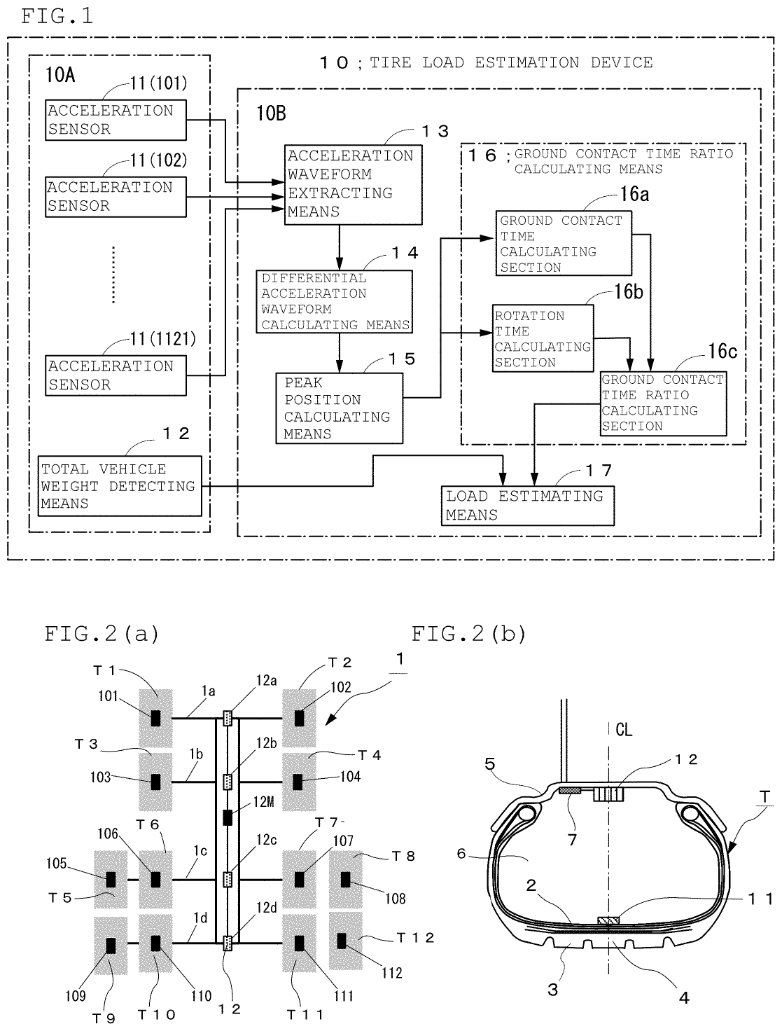

FIG. 1 is a block diagram illustrating a configuration of a tire load estimation device 10 according to an embodiment of the present invention. In FIG. 1, 11 (101˜112) denotes acceleration sensors, 12 denotes a total vehicle weight calculating means, 13 denotes an acceleration waveform extracting means, 14, denotes a differential acceleration waveform calculating means, 15 denotes a peak position calculating means, 16 denotes a ground contact time ratio calculating means and 17 denotes a load estimating means.

The acceleration sensors 101˜112 and the total vehicle weight calculating means 12 constitute a sensor unit 10A, and the respective means from the acceleration waveform extracting means 13 to the load estimating means 17 constitute a calculating unit 10B.

The acceleration waveform extracting means 13 to the load estimating means 17 are each configured, for example, by computer software and a storage device such as a random access memory (RAM), and disposed on a not-shown vehicle body side.

In the present embodiment, an explanation is given as to a case where the number n of tires to be mounted on the vehicle is 12, as illustrated in FIG. 2(a).

The acceleration sensor 11 is, as illustrated in FIGS. 2(a) and 2(b), disposed on an inner liner portion 2 of each of tires T (T1˜T12) of a vehicle 1 at a central portion in the tire width direction indicated by CL in a manner so that a detection direction becomes a tire radial direction, to thereby detect acceleration in the tire radial direction acting on an inner surface of a center portion 4 of a tire tread 3.

As the total vehicle weight calculating means 12, a well-known total vehicle weight calculating means may be used. Namely, such as for example, a total vehicle weight calculating means including weigh detecting units 12a˜12d disposed on axles 1a˜1d and a total vehicle weight calculating unit 12M that calculates a total weight of the vehicle 1 on the basis of outputs of the weigh detecting units 12a˜12d.

Incidentally, in the present embodiment, four (4) of front side tires T1˜T4 are driven wheels, and eight (8) of rear side tires T5˜T12 are driving wheels.

The acceleration waveform extracting means 13 extracts, for each tire Tk (k−=1˜12), an acceleration waveform in the tire radial direction (hereinafter referred to “acceleration waveform”), which is a time-series waveform of acceleration in the tire radial direction, from an acceleration signal in the tire radial direction output from each of the acceleration sensors 101˜112.

The differential acceleration waveform calculating means 14 time-differentiates the acceleration waveform extracted by the acceleration waveform extracting means 13 to obtain a differential acceleration waveform.

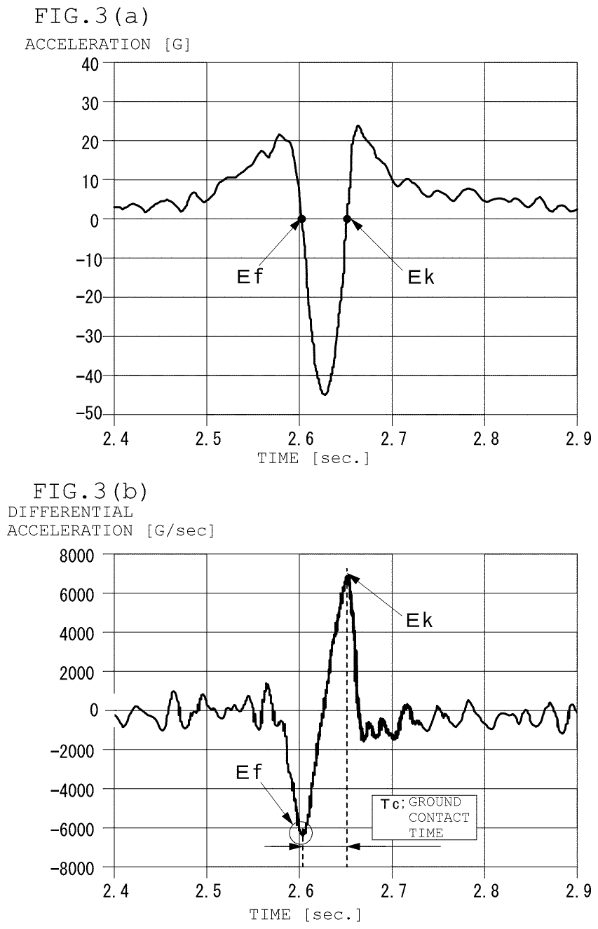

FIG. 3(a) illustrates an example of the acceleration waveform in the tire radial direction detected by the acceleration sensor 11, in which the horizontal axis represents time [sec.] and the vertical axis represents magnitude [G] of acceleration. In the acceleration waveform, the magnitude of the acceleration becomes zero (0) at two ground contact ends, which are a ground contact end on the leading side (hereinafter referred to “leading edge E_{f}) shown by a black circle on the left side in FIG. 3(a) and a ground contact end on the trailing side (hereinafter referred to “trailing edge Eₖ) shown by a black circle on the right side in FIG. 3(a).

FIG. 3(b) illustrates a differential acceleration waveform obtained by differentiating the acceleration waveform illustrated in FIG. 3(a), in which the horizontal axis represents time [sec.] and the vertical axis represents magnitude [G/sec.] of differential acceleration. As illustrated in FIG. 3(b), in the differential acceleration waveform, large peaks appear at the leading edge E_{f} and the trailing edge Eₖ.

The ground contact time T_{c} of the tire is a time interval between a position of the leading edge E_{f} and a position of the trailing edge Eₖ, which are zero-cross points of the acceleration waveform. However, it is difficult to precisely calculate an interval between the zero-cross points, hence in the present embodiment, a time interval between the peak position on the leading side and the peak position on the trailing side, which are two peak positions in the differential acceleration waveform, is defined as the ground contact time T_{c}.

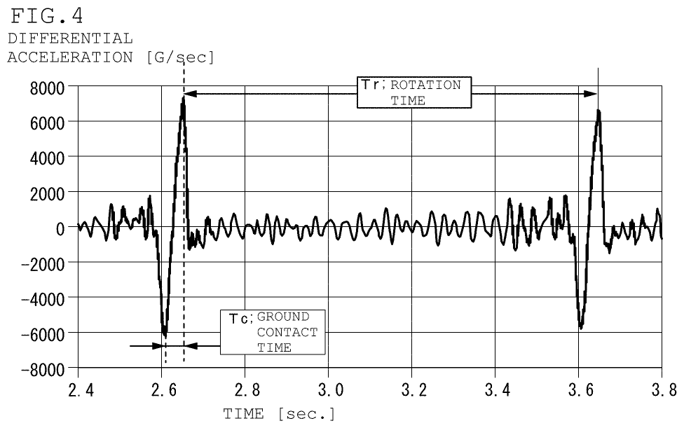

In the meantime, in the present embodiment, as illustrated in FIG. 4, since a rotation time Tr is also calculated in addition to the ground contact time T_{c}, it is desirable to obtain a differential acceleration waveform for at least two rotations of the tire (in reality, it is sufficient to detect at least two peak positions on the leading side or at lest two peak positions on the trailing side).

The ground contact time ratio calculating means 16 includes a ground contact time calculating section 16a, a rotation time calculating section 16b and a ground contact time ratio calculating section 16c, and calculates a ground contact time ratio CTRₖ=T_{ck}/Tᵣₖ of each tire Tk.

More specifically, the ground contact time calculating section 16a calculates the time interval between the peak position on the leading side and the peak position on the trailing side that appear in the differential acceleration waveform illustrated in FIG. 4, and sends the calculated time interval to the ground contact time ratio calculating section 16c as the ground contact time T_{ck}.

The rotation time calculating section 16b calculates the time interval between temporally-adjacent two peaks on the leading side or the time interval between temporally-adjacent two peaks on the trailing side, and sends the calculated time interval to the ground contact time ratio calculating section 16c as the rotation time Tᵣₖ.

The ground contact time ratio calculating section 16c calculates the ground contact time ratio CTRₖ=T_{ck}/Tᵣₖ by using the calculated ground contact time T_{ck} and the calculated rotation time Tᵣₖ, and sends the calculated ground contact time ratio to the load estimating means 17.

The ground contact time T_{ck}, the rotation time Tᵣₖ and the ground contact time ratio CTRₖ are calculated for each tire Tk.

The load estimating means 17 estimates a load wₖ acting on the tire Tk by using the following formulae (1) and (2) from the ground contact time ratio CTRₖ of each tire Tk calculated by the ground contact time ratio calculating means 16, a maximum load capability M of the target tire (tire Tk) which is a target for estimation of the load wₖ, the total vehicle weight W calculated by the total vehicle weight calculating means 12, and a change rate a, which has been obtained in advance, of a maximum load capability ratio Mₖ[%]=wₖ/M to the ground contact time ratio CTRₖ.

Mₖ[%]=(wₖ/M)×100=a×CTRₖ+b (1)

W=w₁+w₂+ . . . +wₙ (2)

Incidentally, the above-mentioned a is an inclination obtained by approximating Mₖ [%] with the linear function a×CTRₖ+b, which is stored in a not-shown memory of the load estimating means 17, together with the maximum load capability M determined by a tire size.

The maximum load capability ratio Mₖ [%] is a value obtained by normalizing the load wₖ acting on the tire Tk with the maximum load capability M of the tire Tk.

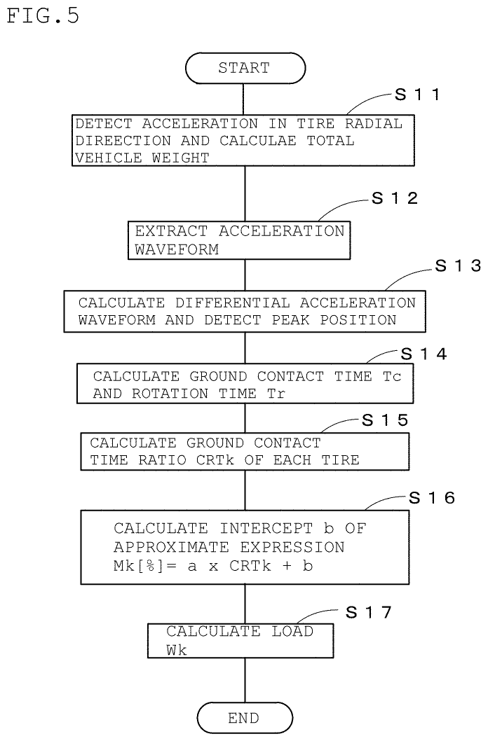

Next, the method for estimating, by using the tire load estimation device 10, the load acting on the tire 1 will be described with reference to the flowchart of FIG. 5.

First, detecting, by the respective acceleration sensors 101˜112 mounted on the respective tires T1˜T12 of the vehicle 1, the acceleration in the tire radial direction on the inner surface of the inner liner portion 2, which deforms along with deformation of the tire tread 3; calculating a total weight of the vehicle 1 by the total vehicle weight calculating means 12; and transmitting, from a transmitter 7 to the calculating unit 10B disposed on the vehicle body side, data of the detected acceleration in the tire radial direction and the calculated total weigh of the vehicle 1 (step S11).

Then, extracting, by the calculating unit 10B, acceleration waveforms from signals that are continuously outputted from the acceleration sensors 101˜112 and that represent the magnitude of accelerations in the tire radial direction acting on the tire tread 3 (step S12).

Then, after time-differentiating the extracted acceleration waveform to obtain the differential acceleration waveform, detecting, from the differential acceleration waveform, the peak position on the leading edge E_{f} side, the peak position on the trailing edge Eₖ side, and the peak position on the trailing edge Eₖ side after rotating the tire for one rotation (step S13).

Then, calculating the ground contact time T_{ck} from the time interval between the peak position on the leading edge E_{f} side and the peak position on the trailing edge Eₖ side, and calculating the rotation time Tᵣₖ from the time interval between two adjacent peak positions on the trailing edge Eₖ side (step S14). Thereafter, calculating, for each tire Tk (k=1˜12), the ground contact time ratio CTRₖ=T_{ck}/Tᵣₖ which is the ratio between the ground contact time T_{ck} and the rotation time Tᵣₖ (step S15).

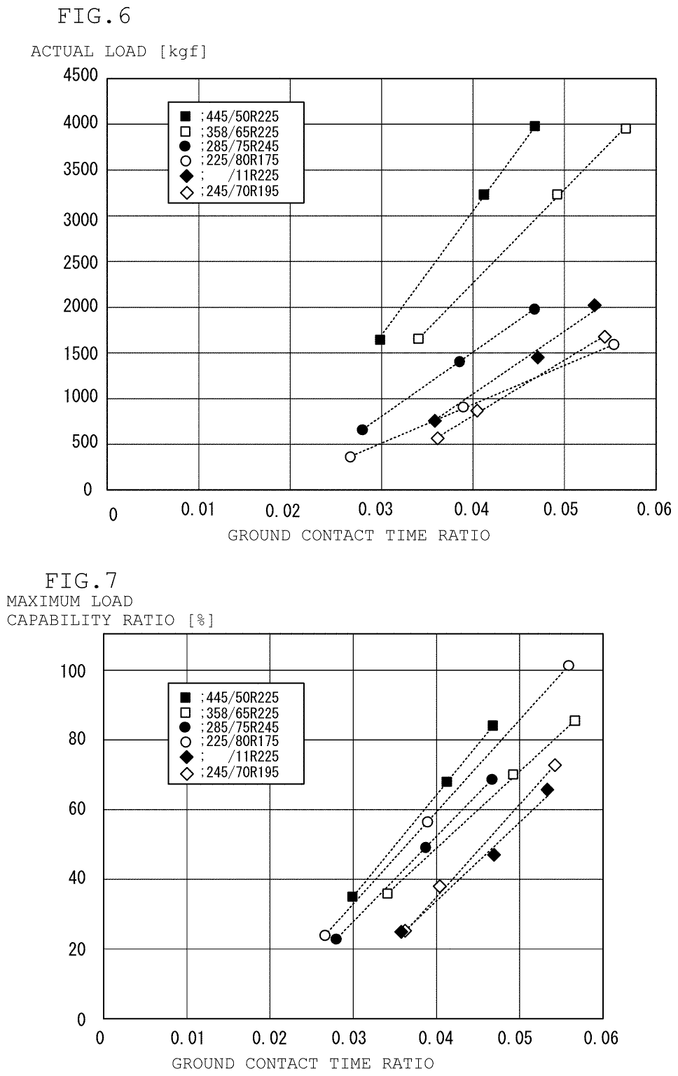

FIG. 6 illustrates a map representing a relationship between the load wₖ and the ground contact time ratio CTRₖ of various tire sizes. The sizes of the tires used include the rim diameter of 17.5 inches, 19.5 inches, 22.5 inches and 24.5 inches, and the flatness ratio of 90, 80, 75 70, 65 and 50.

As illustrated in FIG. 6, the ground contact time ratio CTRₖ and the load wₖ have a substantially linear relationship. In other words, the ground contact time ratio CTRₖ and the load wₖ can be expressed by the approximate expression expressed by the following formula (3).

wₖ=mₖ×CTRₖ+cₖ (3)

Accordingly, by creating in advance the map which can be expressed by the approximate expression (3) for each tire size, and from this map and the calculated ground contact time ratio CTRₖ, the load w_{K} of the tire Tk can be estimated.

However, to achieve this, it is necessary to create the map representing the relationship between the ground contact time ratio CTR_{K} and the load wₖ for each tire size.

Therefore, instead of the load wₖ, by using the maximum load capability ratio Mₖ [%]=(wₖ/Mₖ)×100 which is a value obtained by normalizing the load wₖ acting on the target tire Tk with the maximum load capability Mₖ which is known tire information determined by the load index, the relationship between the ground contact time ratio CTR and the real load w illustrated in FIG. 6 is corrected to the relationship between the ground contact time ratio CTR and the maximum load capability ratio Mₖ [%] as illustrated in FIG. 7.

As illustrated in FIG. 7, because the inclination a of the maximum load capacity ratio Mₖ [%] with respect to the ground contact time ratio CTR is constant irrespective of the tire size, it is possible to convert the maximum load capacity ratio Mₖ [%] into the approximate expression (expression of a linear function) shown in the below formula (1).

M_{K}[%]=(W_{K}/M)×100=a×CTR_{K}+b (1)

In the formula (1), the inclination a is a value that does not depend on the tire size, and the intercept b can be obtained, as described later, from the maximum load capacity M, the total vehicle weight W, the inclination a, and the ground contact time ratios CTR₁˜CTR₁₂ calculated in step S15.

In step S16, the intercept b is obtained from the inclination a in the approximate expression indicating the relationship between the ground contact time ratio CTRₖ and the maximum load capacity ratio Mₖ [%], the formula (1), and the below formula (2) indicating the relationship between the total sum of the loads wₖ and the total vehicle weight W.

W=w₁+w₂+ . . . +wₙ (2)

Specifically, the formula (1) is modified as follows, and substituted for the formula (2).

W_{K}=/(M/100) . . . (a×CTR_{K}+b) (1)′

Since the total number of tires T is, n=12,

W=(M/100)·{a×(CTR₁+CTR₂+ . . . +CTR₁₂)+12b} (2)′

The maximum load capacity M and the inclination a are known, the total vehicle weight W is the value calculated by the total vehicle weight calculating means 12, and the ground contact time ratios CTR₁˜CTR₁₂ are the values calculated form the outputs of the acceleration sensors 101˜112. Therefore, the intercept b can be obtained from the formula (2)′.

In step S17, returning back to the above formula (1), estimating the load wₖ acting on the tire Tk from the inclination a, the intercept b and the ground contact time ratio CTRₖ obtained in step S15.

Thus, without creating in advance the map representing the relationship between the ground contact time ratio CTRₖ and the load wₖ, the load wₖ acting on the target tire Tk can be estimated.

Incidentally, the tire Tk, which is the target for estimation of the load wₖ, may be only driven wheels (tires T1˜T4), or may be only driving wheels (tires T5˜T12). Further, only the load wₖ of a particular tire Tk may be estimated, or the load wₖ of all the tires Tk may be estimated.

Incidentally, in the above-described embodiment, the number of tires T was 12, however, it is needless to say that the present invention may be applied to a vehicle, the number of tires T thereof is four (4), as in the case of passenger cars.

In summary, it can also be described as follows. That is, the present invention provides a method for estimating a load acting on a tire mounted on a vehicle, the method including: a step of detecting an acceleration waveform in a tire radial direction of each tire from an output of each of acceleration sensors disposed on an inner surface side of a tire tread of each tire of the vehicle; a step of calculating a total vehicle weight; a step of differentiating the acceleration waveform in the tire radial direction of each tire to obtain a differential acceleration waveform; a step of calculating a ground contact time and a rotation time of the tire from the differential acceleration waveform; a step of calculating, for each tire, a ground contact time ratio which is a ratio between the ground contact time and the rotation time; and a step of estimating a load acting on a target tire, which is a target for estimation of the load, from the calculated ground contact time ratio of each tire, a maximum load capability of the target tire, the calculated total vehicle weight, and an inclination obtained in advance by approximating a maximum load capability ratio with a linear function of the ground contact time ratio, in which the maximum load capability ratio of the target tire is a value obtained by normalizing the load acting on the target tire with the maximum load capability of the target tire.

With the above-described configuration, the load acting on the tire can be estimated accurately with less sensors, and the load acting on the tire can be estimated without creating the map representing the relationship between the ground contact time ratio and the load.

In addition, in the step of estimating the load, because the load wₖ acting on the target tire Tk is obtained with the use of the following formulae (1) and (2), the load wₖ acting on the target tire Tk can be estimated accurately, where n is the total number of the tires, Mₖ [%] is the maximum load capability ratio of the target tire Tk, CTRₖ is the ground contact time ratio of the tire Tk, and W is the total vehicle weight.

Mₖ [%]=(wₖ/M)×100=a×CTRₖ+b (1)

W=w₁+w₂+ . . . +wₙ (2)

M: the maximum load capability of the target tire Tk

Further, the present invention provides a device for estimating a load acting on a tire mounted on a vehicle, the device including: acceleration sensors each disposed on an inner surface side of a tire tread of each tire of the vehicle and each being configured to detect an acceleration in a tire radial direction of each tire; a total vehicle weight calculating means that calculates a total vehicle weight; an acceleration waveform extracting means that extracts, for each tire, an acceleration waveform in the tire radial direction including a vicinity of a contact patch from an output signal of each of the acceleration sensors; a differential calculating means that differentiates the acceleration waveform in the tire radial direction to obtain a differential acceleration waveform; a peak position detecting means that detects a peak position on a leading edge side and a peak position on a trailing edge side, the peak positions being peak positions at two ground contact ends appearing in the differential acceleration waveform; a ground contact time calculating means that calculates a ground contact time which is an interval between the peak position on the leading edge side and the peak position on the trailing edge side: a rotation time calculating means that calculates a rotation time, which is a time required for the tire to rotate for one rotation, from an interval between two adjacent peak positions on the leading edge side or two adjacent peak positions on the trailing edge side in the acceleration waveform in the tire radial direction; a ground contact time ratio calculating means that calculates, for each tire, a ground contact time ratio which is a ratio between the ground contact time and the rotation time; and a lord estimating means that estimates the load acting on a target tire, which is a target for estimation of the load, from the calculated ground contact time ratio of each tire, a maximum load capability of the target tire, the calculated total vehicle weight, and an inclination obtained in advance by approximating a maximum load capability ratio with a linear function of the ground contact time ratio, in which the maximum load capability ratio of the target tire is a value obtained by normalizing the load acting on the target tire with the maximum load capability of the target tire.

By employing the configuration described above, it is possible to realize the tire load estimation device with a high precision.

### REFERENCE SIGN LIST

1: tire, 2: inner liner portion, 3: tire tread, 4: center portion, 5: wheel rim, 6: tire air chamber, 7: transmitter, 10: tire load estimation device, 10A: sensor unit, 10B: calculating unit, 11: acceleration sensor, 12: total vehicle weight calculating means, 13: acceleration waveform extracting means, 14: differential acceleration waveform calculating means, 15: peak position calculating means, 16: ground contact time ratio calculating means, 16a: ground contact time calculating section, 16b: rotation time calculating section, 16c: ground contact time ratio calculating section, 17: load estimating means.

1. A method for estimating a load acting on a tire mounted on a vehicle, the method comprising:
a step of detecting an acceleration waveform in a tire radial direction of each tire from an output of each of acceleration sensors disposed on an inner surface side of a tire tread of each tire of the vehicle;
a step of calculating a total vehicle weight;
a step of differentiating the acceleration waveform in the tire radial direction of each tire to obtain a differential acceleration waveform;
a step of calculating a ground contact time and a rotation time of the tire from the differential acceleration waveform;
a step of calculating, for each tire, a ground contact time ratio which is a ratio between the ground contact time and the rotation time; and
a step of estimating a load acting on a target tire, which is a target for estimation of the load, from the calculated ground contact time ratio of each tire, a maximum load capability of the target tire, the calculated total vehicle weight, and an inclination obtained in advance by approximating a maximum load capability ratio with a linear function of the ground contact time ratio,
wherein the maximum load capability ratio of the target tire is a value obtained by normalizing the load acting on the target tire with the maximum load capability of the target tire.

2. The method for estimating a load acting on a tire mounted on a vehicle according to claim 1, wherein, in the step of estimating the load, the load wₖ acting on the target tire Tk is obtained from the following formulae (1) and (2) when a total number of the tires is n, the formula (1) representing a relationship between the maximum load capability ratio Mₖ [%] of the target tire Tk and the ground contact time ratio CTRₖ of the target tire Tk, and the formula (2) representing a relationship between a total sum of the loads wₖ and the total vehicle weight W,
Mₖ [%]=(wₖ/M)×100=a×CTRₖ+b (1)
W=w₁+w₂+ . . . +wₙ (2)
M: the maximum load capability of the target tire Tk.

3. A device for estimating a load acting on a tire mounted on a vehicle, the device comprising:
acceleration sensors each disposed on an inner surface side of a tire tread of each tire of the vehicle and each being configured to detect an acceleration in a tire radial direction of each tire;
a total vehicle weight calculating means that calculates a total vehicle weight;
an acceleration waveform extracting means that extracts, for each tire, an acceleration waveform in the tire radial direction including a vicinity of a contact patch from an output signal of each of the acceleration sensors;
a differential calculating means that differentiates the acceleration waveform in the tire radial direction to obtain a differential acceleration waveform;
a peak position detecting means that detects a peak position on a leading edge side and a peak position on a trailing edge side, the peak positions being peak positions at two ground contact ends appearing in the differential acceleration waveform;
a ground contact time calculating means that calculates a ground contact time which is an interval between the peak position on the leading edge side and the peak position on the trailing edge side:
a rotation time calculating means that calculates a rotation time, which is a time required for the tire to rotate for one rotation, from an interval between two adjacent peak positions on the leading edge side or two adjacent peak positions on the trailing edge side in the acceleration waveform in the tire radial direction;
a ground contact time ratio calculating means that calculates, for each tire, a ground contact time ratio which is a ratio between the ground contact time and the rotation time; and
a lord estimating means that estimates the load acting on a target tire, which is a target for estimation of the load, from the calculated ground contact time ratio of each tire, a maximum load capability of the target tire, the calculated total vehicle weight, and an inclination obtained in advance by approximating a maximum load capability ratio with a linear function of the ground contact time ratio,
wherein the maximum load capability ratio of the target tire is a value obtained by normalizing the load acting on the target tire with the maximum load capability of the target tire.
